(19) United States
(12) Patent Application Publication
(10) Pub. No.: US 2026/0317855 A1
(43) Pub. Date: Oct. 15, 2026

(54) BIOSOURCE DILUENT FOR LIQUID-LIQUID EXTRACTION OF METALS FOR BATTERY RECYCLING

(71) Applicant: TOTALENERGIES ONETECH, Courbevoie (FR)

(72) Inventors: Jean Yves LANSOT, Courbevoie (FR); Zubin ARORA, Courbevoie (FR); Benjamin SWOBODA, Courbevoie (FR)

(73) Assignee: TOTALENERGIES ONETECH, Courbevoie (FR)

(21) Appl. No.: 19/109,401

(22) PCT Filed: Sep. 6, 2023
(86) PCT No.: PCT/EP2023/074391

§ 371 Date: Mar. 6, 2025

(30) Foreign Application Priority Data
Sep. 7, 2022 (FR) FR2208962

(51) Int. Cl. C22B 7/00

(52) U.S. Cl. CPC C22B 7/005

(57) ABSTRACT

The invention relates to the use of a hydrocarbon fluid as diluent for the liquid-liquid extraction of metals, more particularly in a hydrometallurgical method for the recycling of batteries, said hydrocarbon fluid comprising at least 75% by weight of isoparaffins and less than 100 ppm by weight of aromatics, relative to the total weight of the hydrocarbon fluid, said hydrocarbon fluid exhibiting a biodegradability of at least 60% at 28 days, measured as per the standard OECD 301B.

### TECHNICAL FIELD OF THE INVENTION

The invention relates to the use of a biobased isoparaffinic fluid as diluent for the liquid-liquid extraction of metals, more particularly used in a hydrometallurgical method for recycling batteries. The invention further relates to a hydrometallurgy method comprising at least one liquid-liquid extraction step and at least one recovery step of at least one metal.

### PRIOR ART

The global production of lithium-ion batteries will grow exponentially in the coming years, in particular with the development of electric vehicles. According to the International Energy Agency (IEA), the number of electric vehicles in circulation is expected to reach at least 145 million units by 2030.

The expansion of the number of batteries leads to increased needs for recycling.

Currently, the battery recycling methods, developed and being industrialized, generally use a hydrometallurgy step which is a technique of extraction/recovery and purification of metals. The liquid-liquid extraction is carried out with an extractant dissolved as such in a diluent.

In methods of the prior art, the diluent is a hydrocarbon solvent coming from refining, often a kerosene or a dearomatized aliphatic product. The use of such a diluent in the method for recycling batteries leads to the use of non-renewable material, which is in paradoxical with the goal of reducing the impact on the environment.

The goal of the present invention is to provide a biobased hydrocarbon fluid, easily biodegradable, as diluent for the liquid-liquid extraction of metals, used in particular in the recycling of electrodes of electric batteries by a hydrometallurgical method.

### SUMMARY OF THE INVENTION

The invention relates to the use of a hydrocarbon fluid as diluent for the liquid-liquid extraction of metals, said hydrocarbon fluid comprising at least 75% by weight of isoparaffins and less than 100 ppm by weight of aromatics, relative to the total weight of the hydrocarbon fluid, said hydrocarbon fluid exhibiting a biodegradability of at least 60% at 28 days, measured as per the standard OECD 301B.

According to one preferred embodiment, the hydrocarbon fluid comprises, relative to the total weight of the hydrocarbon fluid:
at least 80% by weight of isoparaffins, preferably at least 90% by weight, else preferably at least 95% by weight, and/or
at most 20% by weight of normal paraffins, preferably at most 10% by weight, else preferably at most 5% by weight, and/or
at most 1% by weight of naphthenes, and/or
less than 50 ppm by weight of aromatics.

Preferably, the hydrocarbon fluid has:
a flash point greater than or equal to 80° C., preferably greater than or equal to 110° C., preferably greater than or equal to 120° C., or even greater than or equal to 140° C. as per the standard ASTM D93, and/or
a kinematic viscosity at 40° C. of less than or equal to 5 cSt, preferably less than or equal to 4 cSt, and/or
a biogenic carbon content of at least 90% by weight, preferably at least 95% by weight, else preferably at least 97% by weight, relative to the total weight of the carbon atoms of the hydrocarbon fluid.

According to a preferred embodiment, the hydrocarbon fluid has:
an initial boiling point and a final boiling point in the range going from 200 to 400° C., preferably from 240 to 350° C., else preferably from 250 to 340° C., and/or
a difference between the final boiling point and the initial boiling point ranging from 10° C. to 80° C., preferably from 20° C. to 50° C.

According to one preferred embodiment, the hydrocarbon fluid comprises, relative to the total weight of the hydrocarbon fluid:
from 30 to 60% by weight of C15 isoparaffins and from 30 to 60% by weight of C16 isoparaffins, or
from 5 to 15% by weight of C15 isoparaffins, from 30 to 60% by weight of C16 isoparaffins, from 10 to 30% by weight of C17 isoparaffins, and from 10 to 30% by weight of C18 isoparaffins,
from 10 to 30% by weight of C17 isoparaffins and from 60 to 90% by weight of C18 isoparaffins.

According to one embodiment, the hydrocarbon fluid according to the invention has a flash point ranging from 80° C. to 95° C. (ASTM D93) and comprises, relative to the total weight of the hydrocarbon fluid:
from 0.5 to 15% by weight of isoparaffins having less than 13 carbon atoms,
from 5 to 25% by weight of C13 isoparaffins, and
from 5 to 30% by weight of C14 isoparaffins, and
from 5 to 30% by weight of C15 isoparaffins, and
from 25 to 50% by weight of C16 isoparaffins, and
from 10 to 25% by weight of isoparaffins having more than 16 carbon atoms, relative to the total weight of the hydrocarbon fluid,
preferably, said fluid comprises from 75 to 90% by weight of isoparaffins, preferably from 10 to 25% by weight of n-paraffins, relative to the total weight of the fluid.

According to one embodiment, the hydrocarbon fluid is used in a mixture with from 0.01 to 5% by weight of one or more antioxidant additives, relative to the total weight of the hydrocarbon fluid and of the antioxidant additive(s).

Preferably, the fluid is used as diluent in a hydrometallurgical method comprising at least one liquid-liquid extraction of metals using an extraction solution comprising said diluent and at least one extractant. Preferably, the metals come from the recycling of one or more batteries.

The invention further relates to a method for liquid-liquid extraction of metals comprising at least one step of contacting a solution of metals M with an extraction solvent, said extraction solvent comprising at least one diluent and at least one extractant, said diluent being a hydrocarbon fluid comprising at least 75% by weight of isoparaffins and less than 100 ppm by weight of aromatics, relative to the total weight of the hydrocarbon fluid, said hydrocarbon fluid having a biodegradability of at least 60% at 28 days, measured as per the standard OECD 301B.

The invention further relates to a hydrometallurgical method for recycling batteries, said method comprising:
a step of dissolving the metals present in at least one battery, in particular in the electrodes of said at least one battery, to obtain a solution of metals M,
optionally, a clarification step carried out on said solution of metals M in order to remove the residues that are not dissolved in the solution of metals,
a liquid-liquid extraction of metals method according to the invention.

Preferably, the hydrocarbon fluid used in the liquid-liquid extraction of metals method according to the invention or in the hydrometallurgical method for recycling batteries according to the invention comprises one or more of the following characteristics:
the hydrocarbon fluid comprises, relative to the total weight of the hydrocarbon fluid:
   at least 80% by weight of isoparaffins, preferably at least 90% by weight, else preferably at least 95% by weight, and/or
   at most 20% by weight of normal paraffins, preferably at most 10% by weight, else preferably at most 5% by weight, and/or
   at most 1% by weight of naphthenes, and/or
   less than 50 ppm by weight of aromatics,
the hydrocarbon fluid has:
   a flash point greater than or equal to 80° C., preferably greater than or equal to 110° C., preferably greater than or equal to 120° C., or even greater than or equal to 140° C. as per ASTM D93, and/or
   a kinematic viscosity at 40° C. of less than or equal to 5 cSt, preferably less than or equal to 4 cSt, and/or
   a biogenic carbon content of at least 90% by weight, preferably at least 95% by weight, else preferably at least 97% by weight, relative to the total weight of the carbon atoms of the hydrocarbon,
the hydrocarbon fluid has:
   an initial boiling point and a final boiling point in the range going from 200 to 400° C., preferably from 240 to 350° C., else preferably from 250 to 340° C., and/or a difference between the final boiling point and the initial boiling point ranging from 10° C. to 80° C., preferably from 20° C. to 50° C.,
the hydrocarbon fluid comprises, relative to the total weight of the hydrocarbon fluid:
   from 30 to 60% by weight of C15 isoparaffins and from 30 to 60% by weight of C16 isoparaffins, or
   from 5 to 15% by weight of C15 isoparaffins, from 30 to 60% by weight of C16 isoparaffins, from 10 to 30% by weight of C17 isoparaffins, and from 10 to 30% by weight of C18 isoparaffins,
   from 10 to 30% by weight of C17 isoparaffins and from 60 to 90% by weight of C18 isoparaffins,
the hydrocarbon fluid has a flash point ranging from 80° C. to 95° C. and comprises, relative to the total weight of the hydrocarbon fluid:
   from 0.5 to 15% by weight of isoparaffins having less than 13 carbon atoms,
   from 5 to 25% by weight of C13 isoparaffins, and
   from 5 to 30% by weight of C14 isoparaffins, and
   from 5 to 30% by weight of C15 isoparaffins, and
   from 25 to 50% by weight of C16 isoparaffins, and
   from 10 to 25% by weight of isoparaffins having more than 16 carbon atoms, relative to the total weight of the hydrocarbon fluid,
   preferably, said fluid comprises from 75 to 90% by weight of isoparaffins, preferably from 10 to 25% by weight of n-paraffins, relative to the total weight of the fluid.

The hydrocarbon fluid according to the invention has a low density, more particularly a lower density than hydrocarbon solvents of petroleum origin (fossil), which makes it particularly efficient for the use thereof as diluent for the liquid-liquid extraction of metals.

The hydrocarbon fluid according to the invention is particularly stable. Indeed, it has excellent thermal stability, excellent oxidation stability and excellent UV stability, which makes it possible to extend the life of the diluent and thereby minimize the steps of replacing the diluent.

The hydrocarbon fluid according to the invention has a low evaporation for a given flash point, which makes it possible to reduce the loss of fluid by evaporation and thus to improve the yields and the implementation of the method.

The invention makes it possible to provide a biobased diluent having excellent extraction properties when used in an extraction solvent comprising a metal extractant.

The hydrocarbon fluid defined in the invention thereby has good compatibility with metal extractants, more particularly for metals used in electric batteries.

Indeed, the inventors have discovered that the hydrocarbon fluid defined in the present invention has a diluent/extraction pair having good extractability for metals including in particular excellent selectivity toward the metals of interest.

More specifically, the invention proposes a method for recycling electric batteries using a diluent of biobased origin, thereby having a lower impact on the environment, making it possible to selectively recover and reuse metals with an improved yield.

### DETAILED DESCRIPTION OF THE INVENTION

The invention relates to the use of a hydrocarbon fluid as diluent for the liquid-liquid extraction of metals, more particularly in a hydrometallurgical method, said hydrocarbon fluid comprising at least 75% by weight of isoparaffins and less than 100 ppm by weight of aromatics, relative to the total weight of the hydrocarbon fluid, said hydrocarbon fluid having a biodegradability of at least 60% at 28 days, measured as per the standard OECD 301B.

A further subject matter of the present invention is a method for liquid-liquid extraction of metals comprising at least one step of contacting a solution of metals M with an extraction solvent, said extraction solvent comprising at least one diluent and at least one extractant, said diluent being a hydrocarbon fluid comprising at least 75% by weight of isoparaffins and less than 100 ppm by weight of aromatics, relative to the total weight of the hydrocarbon fluid, said hydrocarbon fluid having a biodegradability of at least 60% at 28 days, measured as per the standard OECD 301B.

Finally, the subject matter of the present invention is a hydrometallurgical method for recycling batteries, said method comprising:
a step of dissolving the metals present in at least one battery, in particular in the electrodes of said at least one battery, to obtain a solution of metals M,
optionally, a clarification step carried out on said solution of metals M in order to remove the residues that are not dissolved in the solution of metals,
a step of liquid-liquid extraction of metals comprising at least one step of contacting the solution of metals M with an extraction solvent, said extraction solvent comprising at least one diluent and at least one extractant, said diluent being a hydrocarbon fluid comprising at least 75% by weight of isoparaffins and less than 100 ppm by weight of aromatics, relative to the total weight of the hydrocarbon fluid, said hydrocarbon fluid having a biodegradability of at least 60% at 28 days, measured as per the standard OECD 301B.

The hydrocarbon fluid used in the invention is typically of biobased origin.

As a preliminary matter, it should be noted that, in the following description and claims, the expression “comprised between” has to be understood as including the limits mentioned.

As defined by the present invention, the word “paraffins” includes isoparaffins and n-paraffins.

The word “isoparaffins”, as defined by the present invention, refers to non-cyclic branched alkanes.

The word “n-paraffins”, as defined by the present invention, refers to linear non-cyclic alkanes.

The word “naphtenes”, as defined by the present invention, refers to cyclic (non-aromatic) alkanes.

### Hydrocarbon Fluid Used as a Diluent:

The hydrocarbon fluid used according to the invention comprises a weight content of at least 75% of isoparaffins, preferably a weight content of at least 80% of isoparaffins, else preferably a weight content of at least 90% of isoparaffins, or even a weight content of at least 95% of isoparaffins, relative to the total weight of the hydrocarbon fluid.

The hydrocarbon fluid used according to the invention comprises a weight content of less than or equal to 25% of normal paraffins, preferably a weight content of less than or equal to 20% of normal paraffins, else preferably a weight content of less than or equal to 10% of normal paraffins, or even a weight content of less than or equal to 5% of normal paraffins, relative to the total weight of the hydrocarbon fluid.

Preferably, the hydrocarbon fluid used according to the invention has a mass ratio of isoparaffins to normal paraffins of at least 4:1, preferably of at least 9:1, more preferably of at least 12:1, preferably of at least 15:1, or even of at least 19:1.

Preferably, the hydrocarbon fluid used according to the invention comprises, relative to the total weight of the hydrocarbon fluid, a weight content of naphthenic compounds of less than or equal to 1%, preferentially less than or equal to 0.5% and more preferentially less than or equal to 100 ppm.

According to one embodiment, the hydrocarbon fluid used according to the invention comprises at least 80% by weight of isoparaffins, less than 20% by weight of n-paraffins, less than 1% by weight of naphtenes and less than 100 ppm by weight of aromatics, relative to the total weight of the hydrocarbon fluid.

According to one embodiment, the hydrocarbon fluid used according to the invention comprises, relative to the total weight of the hydrocarbon fluid, a weight content of isoparaffins ranging from 90 to 100% and a weight content of normal paraffins ranging from 0 to 10%, preferentially from 95 to 100% of isoparaffins and from 0 to 5% of normal paraffins and more preferentially from 98% to 100% of isoparaffins and from 0 to 2% of normal paraffins.

According to a preferred embodiment, the hydrocarbon fluid used according to the invention comprises a weight content of isoparaffins ranging from 90 to 100%, a weight content of normal paraffins ranging from 0 to 10% and a weight content of naphthenes of less than or equal to 1%, relative to the total weight of the hydrocarbon fluid.

Preferentially, the hydrocarbon fluid used according to the invention comprises a weight content ranging from 95 to 100% of isoparaffins, a weight content ranging from 0 to 5% of normal paraffins and a weight content of less than or equal to 0.5% of naphthenes, relative to the total weight of the hydrocarbon fluid.

More preferentially, the hydrocarbon fluid used according to the invention comprises a weight content ranging from 98% to 100% of isoparaffins, from 0 to 2% of normal paraffins and a weight content of naphthenes of less than or equal to 100 ppm, relative to the total weight of the hydrocarbon fluid.

The weight contents of isoparaffins, of normal paraffins and of naphthenes can be determined according to any methods known to a person skilled in the art, e.g. by gas chromatography.

The hydrocarbon fluid used according to the invention comprises less than 100 ppm by weight of aromatics, preferably less than 50 ppm by weight of aromatics, else preferably less than 20 ppm by weight of aromatics, relative to the total weight of the hydrocarbon fluid.

The content of aromatics can be determined according to any methods known to a person skilled in the art, e.g. by UV spectrometry.

According to a preferred embodiment, the hydrocarbon fluid used according to the invention comprises a weight content of isoparaffins ranging from 90 to 100%, a weight content of normal paraffins ranging from 0 to 10% and a weight content of naphthenes of less than or equal to 1%, and a weight content of aromatic compounds of less than or equal to 100 ppm. Preferentially, the hydrocarbon fluid used according to the invention comprises a weight content ranging from 95 to 100% of isoparaffins, from 0 to 5% of normal paraffins, a weight content of naphthenes of less than or equal to 0.5% and a weight content of aromatic compounds of less than or equal to 50 ppm. Preferentially also, the hydrocarbon fluid used according to the invention comprises a weight content ranging from 95 to 100% of isoparaffins, from 0 to 5% of normal paraffins and a weight content of aromatic compounds of less than or equal to 100 ppm. More preferentially, the hydrocarbon fluid used according to the invention comprises a weight content ranging from 98% to 100% of isoparaffins, from 0 to 2% of normal paraffins, a weight content of naphthenes of less than or equal to 100 ppm and a weight content of aromatic compounds of less than or equal to 100 ppm.

According to one embodiment, the hydrocarbon fluid used according to the invention has a biogenic carbon content of at least 90% by weight, preferably at least 95% by weight, else preferably at least 97% by weight, relative to the total weight of the carbon atoms of the hydrocarbon,

The content of biogenic carbon (also called carbon of biological origin) can be determined as per the standard ASTM D6866 of 2020.

According to one embodiment, the hydrocarbon fluid used according to the invention comprises at least 80% by weight of isoparaffins, less than 20% by weight of n-paraffins, less than 1% by weight of naphtenes and less than 100 ppm by weight of aromatics, relative to the total weight of the hydrocarbon fluid and has a weight content of biogenic carbon of at least 90%, relative to the total weight of the carbon atoms of the hydrocarbon fluid.

According to one embodiment, the hydrocarbon fluid used according to the invention comprises at least 90% by weight of isoparaffins, less than 10% by weight of n-paraffins, less than 1% by weight of naphtenes and less than 100 ppm by weight of aromatics, relative to the total weight of the hydrocarbon fluid and has a weight content of biogenic carbon of at least 90%, relative to the total weight of the carbon atoms of the hydrocarbon fluid.

The hydrocarbon fluid used according to the invention also preferably has an extremely low weight content of sulfur compounds, typically less than or equal to 5 ppm, preferentially less than or equal to 3 ppm and more preferentially less than or equal to 0.5 ppm at a level that is too low to be detected by means of conventional analyzers of low sulfur content.

The hydrocarbon fluid used according to the invention also preferably has a flash point greater than or equal to 80° C., preferably greater than or equal to 110° C., preferentially greater than or equal to 120° C. and more preferentially greater than or equal to 140° C. as per the standard ASTM D93. A high flash point, typically greater than 110° C., makes it possible in particular to overcome safety problems during storage and transport while preventing an excessively sensitive flammability of the hydrocarbon fluid.

According to one embodiment, the hydrocarbon fluid used according to the invention has a flash point ranging from 80° C. to 105° C. as per the standard ASTM D93. The inventors have observed that the flash point range makes it possible to further improve the performance of the diluent within the framework of liquid-liquid extraction and more particularly for recycling batteries.

The hydrocarbon fluid used according to the invention also preferably has a vapor pressure at 20° C. of less than or equal to 0.01 kPa.

According to one embodiment, the hydrocarbon fluid used according to the invention also preferably has a flash point greater than or equal to 110° C. as per the standard ASTM D93 and a vapor pressure at 20° C. less than or equal to 0.01 kPa.

Preferentially, the hydrocarbon fluid used according to the invention has a flash point greater than or equal to 120° C. and a vapor pressure at 20° C. less than or equal to 0.01 kPa.

And more preferentially, the hydrocarbon fluid used according to the invention has a flash point greater than or equal to 140° C. and a vapor pressure at 20° C. less than or equal to 0.01 kPa.

Furthermore, the hydrocarbon fluid used according to the invention preferably has a kinematic viscosity at 40° C. of less than or equal to 5 cSt, preferentially less than or equal to 4 cSt, measured as per the standard ASTM D445.

Preferably, the hydrocarbon fluid used according to the invention has an initial boiling point and a final boiling point in the range from 200 to 400° C., preferably from 240 to 350° C., else preferably from 250 to 340° C.

The boiling points can be determined as per the standard ASTM D86.

Preferably, the difference between the final boiling point and the initial boiling point ranges from 10° C. to 80° C., preferably from 20° C. to 50° C.,

According to one embodiment, the hydrocarbon fluid used according to the invention comprises at least 80% by weight of isoparaffins, less than 1% by weight of naphthenes and less than 100 ppm by weight of aromatics, and has an initial boiling point and a final boiling point in the range going from 200 to 400° C.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 200 to 400° C.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 250 to 340° C.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 200 to 400° C., the difference between the final boiling point and the initial boiling point ranging from 10° C. to 80° C.

According to a particularly preferred embodiment, the hydrocarbon fluid used according to the invention comprises at least 80% by weight of isoparaffins and less than 100 ppm by weight of aromatics, and has an initial boiling point and a final boiling point in the range going from 250 to 340° C., the difference between the final boiling point and the initial boiling point ranging from 10° C. to 80° C.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 250 to 340° C., the difference between the final boiling point and the initial boiling point ranging from 10° C. to 80° C.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 250 to 340° C., the difference between the final boiling point and the initial boiling point ranging from 20° C. to 50° C.

According to one embodiment, the hydrocarbon fluid used according to the invention comprises, relative to the total weight of the hydrocarbon fluid:
from 20 to 80% by weight of C15 isoparaffins and from 20 to 80% by weight of C16 isoparaffins, wherein said fluid may then comprise isoparaffins having 14 or less carbon atoms and/or isoparaffins having 17 or more carbon atoms; or
from 3 to 20% by weight of C15 isoparaffins, from 20 to 70% by weight of C16 isoparaffins, from 5 to 40% by weight of C17 isoparaffins, and from 5 to 40% by weight of C18 isoparaffins, where said fluid may comprise, optionally, isoparaffins having 14 carbon atoms or less and/or isoparaffins having 19 carbon atoms or more; or
from 5 to 40% by weight of C17 isoparaffins and from 60 to 95% by weight of C18 isoparaffins, where said fluid may optionally comprise isoparaffins having 16 or less carbon atoms and/or isoparaffins having 19 or more carbon atoms.

According to a particular embodiment, the hydrocarbon fluid used according to the invention comprises, relative to the total weight of the hydrocarbon fluid:
from 30 to 60% by weight of C15 isoparaffins and from 30 to 60% by weight of C16 isoparaffins, wherein said fluid may then comprise isoparaffins having 14 or less carbon atoms and/or isoparaffins having 17 or more carbon atoms; or
from 5 to 15% by weight of C15 isoparaffins, from 30 to 60% by weight of C16 isoparaffins, from 10 to 30% by weight of C17 isoparaffins, and from 10 to 30% by weight of C18 isoparaffins, where said fluid may optionally comprise isoparaffins having 14 carbon atoms or less and/or isoparaffins having 19 carbon atoms or more; or
from 10 to 30% by weight of C17 isoparaffins and from 60 to 90% by weight of C18 isoparaffins, where said fluid may optionally comprise isoparaffins having 16 or less carbon atoms and/or isoparaffins having 19 or more carbon atoms.

The term “CX isoparaffins” refers to isoparaffins containing X carbon atoms.

According to one embodiment, the hydrocarbon fluid used according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a weight content of aromatics of less than 100 ppm, relative to the total weight of the hydrocarbon fluid.

According to one embodiment, the hydrocarbon fluid used according to the invention has an initial boiling point and a final boiling point in the range going from 240 to 300° C. and comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a weight content of aromatics of less than 100 ppm, relative to the total weight of the hydrocarbon fluid.

According to one embodiment, the hydrocarbon fluid used according to the invention comprises from 10 to 30% by weight of C17 isoparaffins and from 60 to 90% by weight of C18 isoparaffins and has a weight content of aromatics of less than 100 ppm, relative to the total weight of the hydrocarbon fluid.

According to one embodiment, the hydrocarbon fluid used according to the invention has an initial boiling point and a final boiling point in the range going from 260 to 340° C. and comprises from 10 to 30% by weight of C17 isoparaffins and from 60 to 90% by weight of C18 isoparaffins and has a weight content of aromatics of less than 100 ppm, relative to the total weight of the hydrocarbon fluid.

According to one embodiment, the hydrocarbon fluid used according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a weight content of aromatics of less than 100 ppm, relative to the total weight of the hydrocarbon fluid and said fluid has a weight content of biogenic carbon of at least 95%, relative to the total weight of the carbon atoms of the hydrocarbon fluid.

According to one embodiment, the hydrocarbon fluid used according to the invention has an initial boiling point and a final boiling point in the range going from 240 to 300° C. and comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a weight content of aromatics of less than 100 ppm, relative to the total weight of the hydrocarbon fluid and said fluid has a weight content of biogenic carbon of at least 95%, relative to the total weight of the carbon atoms of the hydrocarbon fluid.

According to one embodiment, the hydrocarbon fluid used according to the invention comprises from 10 to 30% by weight of C17 isoparaffins and from 60 to 90% by weight of C18 isoparaffins and has a weight content of aromatics of less than 100 ppm, relative to the total weight of the hydrocarbon fluid and said fluid has a weight content of biogenic carbon of at least 95%, relative to the total weight of the carbon atoms of the hydrocarbon fluid.

According to one embodiment, the hydrocarbon fluid used according to the invention has an initial boiling point and a final boiling point in the range going from 260 to 340° C. and comprises from 10 to 30% by weight of C17 isoparaffins and from 60 to 90% by weight of C18 isoparaffins and has a weight content of aromatics of less than 100 ppm, relative to the total weight of the hydrocarbon fluid and said fluid has a weight content of biogenic carbon of at least 95%, relative to the total weight of the carbon atoms of the hydrocarbon fluid.

According to one embodiment, the hydrocarbon fluid used according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a weight content of aromatics of less than 50 ppm, relative to the total weight of the hydrocarbon fluid and said fluid has a weight content of biogenic carbon of at least 90%, relative to the total weight of the carbon atoms of the hydrocarbon fluid.

According to one embodiment, the hydrocarbon fluid used according to the invention comprises from 10 to 30% by weight of C17 isoparaffins and from 60 to 90% by weight of C18 isoparaffins and has a weight content of aromatics of less than 50 ppm, relative to the total weight of the hydrocarbon fluid and said fluid has a weight content of biogenic carbon of at least 90%, relative to the total weight of the carbon atoms of the hydrocarbon fluid.

According to a particular embodiment, the hydrocarbon fluid according to the invention has a flash point ranging from 80° C. to 95° C. (ASTM D93) and comprises, relative to the total weight of the hydrocarbon fluid:
from 0.5 to 15% by weight of isoparaffins having less than 13 carbon atoms,
from 5 to 25% by weight of C13 isoparaffins, and
from 5 to 30% by weight of C14 isoparaffins, and
from 5 to 30% by weight of C15 isoparaffins, and
from 25 to 50% by weight of C16 isoparaffins, and
from 10 to 25% by weight of isoparaffins having more than 16 carbon atoms, relative to the total weight of the hydrocarbon fluid,
preferably, said fluid comprises from 75 to 90% by weight of isoparaffins, preferably from 10 to 25% by weight of n-paraffins, relative to the total weight of the fluid.

The inventors have observed that the hydrocarbon fluid had particularly high performance as a diluent within the framework of recycling batteries as defined in the invention.

The hydrocarbon fluid used according to the invention has a biodegradability of at least 60% at 28 days, measured as per the standard OECD 301B. Thereby, typically, the hydrocarbon fluid according to the invention will be called “readily biodegradable”.

In contrast, a product will be called “inherently biodegradable” if same has a biodegradability ranging from 20 to less than 60% at 28 days as per the standard OECD 301, e.g. as per the standard OECD 301B.

According to one embodiment, the hydrocarbon fluid used according to the invention has a biodegradability at 28 days of at least 70%, preferably of at least 80%, measured as per the standard OECD 301B.

Preferably, the hydrocarbon fluid used according to the invention has a biodegradability of at least 60% at 28 days, measured as per the standard OECD 306. The standard OECD 306 is more stringent than the standard OECD 301B.

According to a particularly preferred embodiment, the hydrocarbon fluid used according to the invention comprises at least 80% by weight of isoparaffins and less than 100 ppm by weight of aromatics, and has an initial boiling point and a final boiling point in the range going from 200 to 400° C., said hydrocarbon fluid having a biodegradability of at least 60% at 28 days, measured as per the standard OECD 301B.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 200 to 400° C., said hydrocarbon fluid having a biodegradability of at least 60% at 28 days, measured as per the standard OECD 301B.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 250 to 340° C., said hydrocarbon fluid having a biodegradability of at least 60% at 28 days, measured as per the standard OECD 301B.

According to a particularly preferred embodiment, the hydrocarbon fluid used according to the invention comprises at least 95% by weight of isoparaffins and less than 100 ppm by weight of aromatics, and has an initial boiling point and a final boiling point in the range going from 250 to 340° C., the difference between the final boiling point and the initial boiling point going from 20° C. to 50° C., said hydrocarbon fluid having a biodegradability of at least 60% at 28 days, measured as per the standard OECD 301B.

According to one embodiment, the hydrocarbon fluid used according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a weight content of aromatics of less than 100 ppm, relative to the total weight of the hydrocarbon fluid, said hydrocarbon fluid having a biodegradability of at least 60% at 28 days, measured as per the standard OCDE 301B.

According to one embodiment, the hydrocarbon fluid used according to the invention comprises from 10 to 30% by weight of C17 isoparaffins and from 60 to 90% by weight of C18 isoparaffins and has a weight content of aromatics of less than 100 ppm, relative to the total weight of the hydrocarbon fluid, said hydrocarbon fluid having a biodegradability of at least 60% at 28 days, measured as per the standard OECD 301B.

According to a particularly preferred embodiment, the hydrocarbon fluid used according to the invention comprises at least 95% by weight of isoparaffins and less than 50 ppm by weight of aromatics, and has an initial boiling point and a final boiling point in the range going from 200 to 400° C., said hydrocarbon fluid having a biodegradability of at least 60% at 28 days, measured as per the standard OECD 301B.

According to a particularly preferred embodiment, the hydrocarbon fluid used according to the invention comprises at least 95% by weight of isoparaffins and less than 50 ppm by weight of aromatics, and has an initial boiling point and a final boiling point in the range going from 250 to 340° C., said hydrocarbon fluid having a biodegradability of at least 60% at 28 days, measured as per the standard OECD 301B.

According to a particularly preferred embodiment, the hydrocarbon fluid used according to the invention comprises at least 95% by weight of isoparaffins and less than 50 ppm by weight of aromatics, and has an initial boiling point and a final boiling point in the range going from 250 to 340° C., the difference between the final boiling point and the initial boiling point going from 20° C. to 50° C., said hydrocarbon fluid having a biodegradability of at least 60% at 28 days, measured as per the standard OECD 301B.

According to one embodiment, the hydrocarbon fluid used according to the invention comprises from 5 to 15% by weight of C15 isoparaffins, from 30 to 60% by weight of C16 isoparaffins, from 10 to 30% by weight of C17 isoparaffins, and from 10 to 30% by weight of C18 isoparaffins and has a weight content of aromatics of less than 50 ppm, relative to the total weight of the hydrocarbon fluid, said hydrocarbon fluid having a biodegradability of at least 60% at 28 days, measured as per the standard OCDE 301B.

According to one embodiment, the hydrocarbon fluid used according to the invention comprises from 10 to 30% by weight of C17 isoparaffins and from 60 to 90% by weight of C18 isoparaffins and has a weight content of aromatics of less than 50 ppm, relative to the total weight of the hydrocarbon fluid, said hydrocarbon fluid having a biodegradability of at least 60% at 28 days, measured as per the standard OECD 301B.

### Method for Obtaining the Hydrocarbon Fluid:

The hydrocarbon fluid used according to the invention can be obtained in the following manner. The hydrocarbon fluid used according to the invention is a hydrocarbon fraction typically coming from biomass conversion.

Coming from biomass conversion refers to a hydrocarbon fraction produced from raw materials of biological origin. Raw materials of organic origin can be chosen from vegetable oils, animal fats, fish oils and mixtures thereof.

Preferably, the hydrocarbon fraction of biological origin is obtained by a method comprising hydrodeoxygenation (HDO) and isomerization (ISO) steps. The hydrodeoxygenation (HDO) step leads to the decomposition of the structures of biological esters or of triglyceride constituents, the removal of oxygenated, phosphorus and sulfur compounds and the hydrogenation of olefinic bonds. The product coming from the hydrodeoxygenation reaction is then isomerized. A fractionation step can preferably follow the hydrodeoxygenation and isomerization steps. Advantageously, the fractions of interest are then subjected to hydrotreatment and then distillation steps in order to obtain the specifications of the desired hydrocarbon fluid according to the invention.

The HDO/ISO method is carried out on a raw biological feedstock, also called biomass or raw material of biological origin, selected from the group consisting of vegetable oils, animal fats, fish oils and the mixture thereof. Suitable organic raw materials are e.g. rapeseed oil, canola oil, tall oil, sunflower oil, soybean oil, hemp oil, olive oil, linseed oil, mustard oil, palm oil, peanut oil, castor oil, coconut oil, animal fats such as tallow, recycled food fats, genetically engineered raw materials, and organic raw materials produced from microorganisms such as algae and bacteria. Condensation products, esters or other derivatives obtained from raw biological materials can also be used as raw materials.

Preferably, the raw material of biological origin is an ester or a triglyceride derivative. Such material is first subjected to a hydrodeoxygenation (HDO) step to decompose the structure of the constitutive esters or triglycerides and remove oxygenated, phosphorus and sulfur compounds concomitantly with the hydrogenation of olefinic bonds. The step of hydrodeoxygenation (HDO) of the raw material of biological origin is followed by an isomerization of the resulting product leading to branching of the hydrocarbon chain and to an improvement of the properties of the paraffin at low temperatures.

During the HDO step, hydrogen and the biological raw material are passed through a hydrodeoxygenation catalytic bed simultaneously or in back-flow. During the HDO step, the pressure and temperature are between 20 and 150 bar and between 20° and 500° C., respectively. Conventional and known hydrodeoxygenation catalysts are used during such step. Optionally, the raw material of biological origin can be subjected to pre-hydrogenation under mild conditions so as to prevent secondary reactions of the double bonds before the HDO step. After the hydrodeoxygenation step, the product coming from the reaction is subjected to an isomerization step (ISO) where hydrogen and the product, and, optionally a mixture of n-paraffins, are passed through isomerization catalyst beds simultaneously or in back-flow. During the ISO step, the pressure and temperature are between 20 and 150 bar and between 20° and 500° C., respectively. Conventional and known isomerization catalysts are used during such step.

Additional secondary methods may also be used (e.g. intermediate mixing, scavenging or the like).

The product from the HDO/ISO steps can be split, optionally, so as to obtain the fractions of interest.

Various HDO/ISO methods are described in the literature. Application WO2014/033762 describes a method comprising a pre-hydrogenation step, a hydrodeoxygenation (HDO) step and an isomerization step operated in back-flow. Patent application EP1728844 describes a method for the production of hydrocarbon compounds from a mixture of compounds of plant and animal origin. The method comprises a pre-treatment step of the mixture to remove contaminants, such as alkali metal salts, followed by a hydrodeoxygenation (HDO) step and an isomerization step. Patent application EP2084245 describes a method for the production of a hydrocarbon mixture which can be used as diesel oil or in a diesel oil composition by hydrodeoxygenation of a mixture of biological origin containing fatty acid esters mixed, optionally, with free fatty acids, e.g. vegetable oils such as sunflower oil, rapeseed oil, canola oil, palm oil or pine oil, followed by hydroisomerization on specific catalysts. Patent application EP2368967 describes such a method and the product obtained by the method.

Advantageously, the raw material of biological origin contains less than 15 ppm of sulfur, preferably less than 8 ppm, preferentially less than 5 ppm and more preferentially less than 1 ppm as per the standard EN ISO 20846. Ideally, the feedstock does not include sulfur as a raw material of bio-based origin.

The deoxygenated and isomerized feedstock coming from the HDO/ISO method is then hydrogenated, after being fractionated, optionally, in order to obtain a desired boiling range.

Preferably, the hydrogenation step is a catalytic hydrogenation step at a temperature of 80 to 180° C. and at a pressure of 50 to 160 bars of a deoxygenated and isomerized biological feedstock (or fraction).

The hydrogen used in the hydrogenation unit is typically highly purified hydrogen. Highly purified means that hydrogen with a purity e.g. greater than 99%, even if other grades can also be used.

The hydrogenation step is carried out using catalysts. Typical hydrogenation catalysts may be either bulk catalysts or supported catalysts and may comprise the following metals: nickel, platinum, palladium, rhenium, rhodium, nickel tungstate, nickel-molybdenum, molybdenum, cobalt-molybdenum. The supports can be silica, alumina, silica-alumina or zeolites.

A preferred catalyst is a nickel catalyst supported on alumina with a specific surface area varying preferably between 100 and 200 m²/g of catalyst or a nickel bulk catalyst. The hydrogenation conditions are typically as follows:
Pressure: 50 to 160 bar, preferably 80 to 150 bar and more preferentially 90 to 120 bar;
Temperature: 80 to 180° C., preferably 120 to 160° C., and more preferentially 150 to 160° C.;
Liquid Hourly space velocity (LHSV): 0.2 to 5 hr−1, preferably 0.4 to 3 hr−1 and more preferentially 0.5 to 0.8 hr−1;
Hydrogen treatment rate: suitable for the conditions mentioned hereinabove and up to 200 Nm3/tons of feedstock to be treated.

The temperature in the reactors is typically comprised between 15° and 160° C. with a pressure of about 100 bars while the liquid hourly space velocity is about 0.6 hr−1 with a treatment rate adapted to the quality of the feedstock to be treated and the parameters of the first hydrogenation reactor.

Hydrogenation can take place in one or more reactors in series. The reactors may comprise one or more catalyst beds. Catalyst beds are generally stationary catalyst beds.

The hydrogenation method preferably comprises two or three reactors, preferably three reactors and is more preferentially carried out in three reactors in series.

The first reactor is used for the scavenging of sulfur compounds and the hydrogenation of essentially all unsaturated compounds and up to about 90% by weight of the aromatic compounds. The product coming from the first reactor substantially does not contain any sulfur-containing compound. In the second step, i.e. in the second reactor, the hydrogenation of the aromatics continues and up to 99% by weight of the aromatics are thereby hydrogenated.

The third step in the third reactor is a finishing step to obtain a weight content of aromatics of less than 100 ppm, preferably less than 50 ppm, preferentially less than 20 ppm.

It is possible to use a reactor that has two or three or more catalyst beds. The catalysts may be present in variable or essentially equal quantities in each reactor; for three reactors, the quantities as a function of the weight may e.g. be 0.05-0.5/0.10-0.70/0.25-0.85, preferably 0.07-0.25/0.15-0.35/0.4-0.78 and more preferentially 0.10-0.20/0.20-0.32/0.48-0.70.

It is also possible to use one or two hydrogenation reactors instead of three.

It is also possible for the first reactor to be composed of twin reactors operated alternately. Such mode of operation makes possible in particular easy loading and unloading of catalysts: when the first reactor comprises the catalyst saturated first (substantially all the sulfur is trapped on and/or in the catalyst), it should be changed often.

A single reactor can also be used, wherein two, three or more catalyst beds are installed.

It may be necessary to insert quench boxes in the recycle system or between reactors, to cool the effluents from one reactor to another or from one catalyst bed to another, in order to control the temperatures and the hydrothermal equilibrium of each reaction. According to a preferred embodiment, there are no cooling or quenching intermediates.

According to one embodiment, the product coming from the method and/or the separated gases are at least partially recycled to the feeding system of the hydrogenation reactors. Such dilution contributes to keeping the exothermicity of the reaction within controlled limits, more particularly at the first stage. Furthermore, recycling makes possible a heat exchange before the reaction and also better temperature control.

The effluent from the hydrogenation unit contains mainly the hydrogenated product and hydrogen. Flash separators are used to separate effluents in the gas phase, mainly residual hydrogen, and in the liquid phase, mainly hydrogenated hydrocarbon fractions. The method can be carried out using three flash separators, one at high pressure, one at intermediate pressure and one at low pressure very close to atmospheric pressure.

The gaseous hydrogen collected at the top of the flash separators can be recycled in the feeding system of the hydrogenation unit or at different levels in the hydrogenation units between the reactors.

According to one embodiment, the final product is separated at atmospheric pressure. It then feeds directly to a vacuum fractionation unit. Preferably, the fractionation will be carried out at a pressure comprised between 10 and 50 mbars and more preferentially at about 30 mbars.

The fractionation is carried out in such a way that it is possible to simultaneously remove various hydrocarbon fluids from the fractionation column and that the boiling temperature thereof can be predetermined.

By adapting the feedstock through the initial and final boiling points thereof, the hydrogenation reactors, the separators and fractionation unit can thus be directly connected without the need for intermediate tanks. Such integration of the hydrogenation and the fractionation leads to an optimized thermal integration combined with a reduction in the number of systems and with energy saving.

Thereby, according to one embodiment of the invention, the hydrocarbon fluid used in the invention is obtained by a method comprising a catalytic hydrogenation step of a biomass which has been hydrodeoxygenated and hydroisomerized, said hydrogenation step being carried out at a temperature ranging from 80 to 180° C. and at a pressure ranging from 50 to 160 bar, preferably at a temperature ranging from 120 to 160° C. and at a pressure ranging from 80 to 150 bar, else preferably at a temperature ranging from 150 to 160° C. and at a pressure ranging from 90 to 120 bars.

According to a particular embodiment, the hydrocarbon fluid used according to the invention is obtained by a method comprising:
a hydrodeoxygenation step followed by a hydroisomerization step of a biomass in order to obtain a hydrodeoxygenated and hydroisomerized biomass,
a catalytic hydrogenation step of the hydrodeoxygenated and hydroisomerized biomass, said hydrogenation step being carried out at a temperature ranging from 80 to 180° C. and at a pressure ranging from 50 to 160 bars, preferably at a temperature ranging from 120 to 160° C. and at a pressure ranging from 80 to 150 bar, else preferably at a temperature ranging from 150 to 160° C. and at a pressure ranging from 90 to 120 bar,
the biomass being preferably chosen from vegetable oils, animal fats, fish oils and mixtures thereof.

The hydrocarbon fluid used according to the invention is ideally coming from the treatment of raw materials of biological origin. The term “biogenic carbon” or “bio-carbon” indicates that carbon has a natural origin and comes from a biomaterial, as indicated hereafter. The content of bio-carbon, the content of biogenic carbon and the content of biomaterial are expressions indicating the same value. A renewable material or biomaterial is an organic material wherein carbon comes from CO₂ recently fixed (on a human scale) by photosynthesis from the atmosphere. A biomaterial (100% carbon of natural origin) has an isotopic ratio of ¹⁴C/¹²C greater than 10⁻¹², typically about 1.2×10⁻¹², while a fossil material has a ratio equal to zero. Indeed, the isotopic ¹⁴C formed in the atmosphere is then integrated by photosynthesis, according to a time scale of at most a few decades. The half-life of ¹⁴C is 5730 years. Thereby, the materials resulting from photosynthesis, namely plants in general, necessarily have a maximum content of isotope ¹⁴C.

### Additives

According to one embodiment, the hydrocarbon fluid is mixed with at least one additive before being used as diluent.

According to one embodiment, the diluent used according to the invention comprises the hydrocarbon fluid defined in the present invention and at least one additive, preferably at least one antioxidant additive. The antioxidant additive generally makes it possible to delay the degradation of the composition in service. Such degradation most often shows in a deposit formation, in the presence of sludge or in an increase in the viscosity of the composition.

Antioxidant additives in particular act as radical inhibitors or destroyers of hydroperoxides. The antioxidant additives commonly used include phenolic antioxidants, amine antioxidant additives, phosphosulfur antioxidant additives. Some of such antioxidant additives, e.g. phosphosulfur antioxidant additives, can generate ashes. The phenolic antioxidant additives can be without ashes or in the form of neutral or basic metal salts. The antioxidant additives can in particular be chosen from sterically hindered phenols, sterically hindered phenol esters and sterically hindered phenols comprising a thioether bridge, diphenylamines, diphenylamines substituted with at least one C1-C12 alkyl group, and mixtures thereof.

According to one embodiment, the sterically hindered phenols are chosen from compounds comprising a phenol group of which at least one of the neighboring carbon to the carbon atom bearing the alcohol function is substituted by at least one C1-C10 alkyl group, preferentially a C1-C6 alkyl group, preferentially a C4 alkyl group, preferentially a tert-butyl group.

Amine compounds are another class of antioxidant additives which can be used, optionally, in combination with phenolic antioxidant additives. Examples of amine compounds are aromatic amines, e.g. aromatic amines with the formula NR4R5R6 wherein R4 represents an aliphatic group or an aromatic group, possibly substituted, R5 represents an aromatic group, possibly substituted, R6 represents a hydrogen atom, an alkyl group, an aryl group or a group of the formula R7S(O)zR8 wherein R7 represents an alkylene or alkenylene group, R8 represents an alkyl group, alkenyl group or an aryl group and z stands for 0, 1 or 2.

Sulfur alkyl phenols or the alkali or alkaline-earth metal salts thereof can be further used as antioxidant additives.

Another class of antioxidant additives is the class of copper compounds, e.g. copper thio- or dithio-phosphate, copper salts and carboxylic acid salts, copper dithiocarbamates, copper sulfonates, copper phenates, copper acetylacetonates. Copper salts I and II, succinic acid salts or succinic anhydride salts can be used as well.

If same are used in the diluent, the antioxidant(s) preferably represent(s) from 0.01 to 3% by weight relative to the weight of the composition, preferably from 0.05 to 2% by weight relative to the weight of the diluent.

### Use as Diluent:

The hydrocarbon fluid, optionally mixed with one or more additives, is used as a diluent for the liquid-liquid extraction of metals. More particularly, the hydrocarbon fluid defined in the invention can be used as diluent in a hydrometallurgical method comprising at least one liquid-liquid extraction of metals step.

A further subject matter of the present invention is a method for the liquid-liquid extraction of metals comprising at least one step of contacting a solution of metals M with an extraction solvent, said extraction solvent comprising at least one diluent and at least one extractant, said diluent being a hydrocarbon fluid as defined in the present invention.

Typically, within the framework of the present invention, the liquid-liquid extraction of metals comprises a step of contacting a solution of metals M with an extraction solvent comprising an extractant and a diluent, said diluent being the hydrocarbon fluid defined in the present invention.

Within the framework of the present invention, the solution of metals M typically comprises at least two different metals and the liquid-liquid extraction of metals will make it possible to recover at least one metal from the solution of metals M, preferably at least two metals separately. Said metals may e.g. be chosen from nickel, copper, cadmium, cobalt, manganese, lithium and zinc, and mixtures thereof including alloys of said metals.

The metals of the solution M may be in the form of metal oxide and/or of metal hydroxide.

The extractant may be chosen by a person skilled in the art according to the metals present in the solution of metals M.

Typically, the extractant will be miscible with the hydrocarbon fluid.

According to one embodiment, the extractant is chosen from oximes comprising one or two alkyl groups and phosphorous acids possibly including one or more alkyl groups, alkyls preferably having from 1 to 24 carbon atoms, preferably from 4 to 18 carbon atoms, preferably from ketoximes having an alkyl group, phosphinite acids possibly comprising one or more alkyl groups, alkyls preferably having from 1 to 24 carbon atoms, preferably from 4 to 18 carbon atoms.

By way of non-limiting examples, among the extractants, mention may be made of the extractants of the Cyanex® range from Solvay or the extractants of the LIX® range from BASF.

The solution of metals M can e.g. come from a step of dissolving metals coming from electric batteries, more particularly electrodes of electric batteries.

### Hydrometallurgical Method for Recycling Battery(ies)

A further subject matter of the present invention is a hydrometallurgical method for recycling one or more batteries, said method comprising:
a step of dissolving the metals present in at least one battery, in particular in the electrodes of said at least one battery, to obtain a solution of metals M,
optionally, a clarification step carried out on said solution of metals M in order to remove the residues that are not dissolved in the solution of metals,
a step of liquid-liquid extraction of metals comprising at least one step of contacting the solution of metals M, optionally clarified, with an extraction solvent, said extraction solvent comprising at least one diluent and at least one extractant, said diluent being a hydrocarbon fluid comprising at least 75% by weight of isoparaffins and less than 100 ppm by weight of aromatics, relative to the total weight of the hydrocarbon fluid, said hydrocarbon fluid having a biodegradability of at least 60% at 28 days, measured as per the standard OECD 301B.

Preferably, the method is carried out on lithium-ion batteries.

The method will typically make it possible to recover and reuse the metals present in the batteries, in particular in the electrodes of the batteries.

### Dissolution Step

Within the framework of the present invention, the parts to be recycled, in particular the electrodes of batteries, are typically dissolved, preferably by a leaching method.

A solution comprising metals is thereby obtained, the solution of metals M will generally comprise at least two metals of different nature. The hydrometallurgy method will then make it possible to separately recover said at least two metals of different nature.

The metals present in the solution of metals M may e.g. be chosen from nickel, copper, cadmium, cobalt, manganese, lithium and zinc, the mixtures thereof including alloys of said metals.

For the solution step, a solution L allowing the metals present to be dissolved, more particularly the metals intended to be recovered, will be chosen. The solution L for dissolving may e.g. be chosen from acids, bases, oxidizing agents or reducing agents.

The solution of metals M may thereby comprise metals in oxide or hydroxide form.

### Clarification Step

The hydrometallurgy method according to the invention may comprise, optionally, a clarification step for removing the solid residues that would be present in the solution of metals M.

Such optional clarification step can be, optionally, carried out by decantation and/or centrifugation and/or filtration.

### Liquid-Liquid Extraction Step

The hydrometallurgy method according to the invention comprises a step of liquid-liquid extraction of metals comprising at least one step of contacting the solution of metals M, after an optional clarification step, with an extraction solvent.

The extraction solvent comprises at least one diluent and at least one extractant.

Said diluent is the hydrocarbon fluid defined in the present invention.

The extractant may be chosen by a person skilled in the art according to the metals present in the solution of metals M.

Typically, the extractant will be miscible with the hydrocarbon fluid.

According to one embodiment, the extractant is chosen from oximes comprising one or two alkyl groups and phosphorous acids possibly including one or more alkyl groups, alkyls preferably having from 1 to 24 carbon atoms, preferably from 4 to 18 carbon atoms, preferably from ketoximes having an alkyl group, phosphinite acids possibly comprising one or more alkyl groups, alkyls preferably having from 1 to 24 carbon atoms, preferably from 4 to 18 carbon atoms.

By way of non-limiting examples, among the extractants, mention may be made of the extractants of the Cyanex® range from Solvay or the extractants of the LIX® range from BASF.

The method according to the invention may comprise at least one subsequent step of recovering at least one metal, preferably at least two metals of different nature.

Preferably, said subsequent recovery step is followed by a purification step of said recovered metal or metals.

### Examples

In the remainder of the present description, examples are given by way of illustration of the present invention and under no circumstances are intended to limit its scope.

Three hydrocarbon fluids are prepared according to a method as described in the present invention, by HDO/ISO of a biomass followed by a hydrogenation step.

Table 1 shows the physical and chemical properties of hydrocarbon fluids.

TABLE 1

| | Fluid 1 | Fluid 2 | Fluid 3 |
|---|---|---|---|
| % iso paraffins (w/w) | 98.9 | 95.1 | 96.2 |
| % n-paraffins (w/w) | 1.1 | 4.9 | 3.8 |
| % naphthenics (w/w) | 0 | 0 | 0 |
| Aromatics (ppm) | <20 | <20 | <20 |
| Sulfur (ppm) | 0.1 | 0.1 | 0.11 |
| C13 (iso) | 0.66 | 0 | 0 |
| C14 (iso) | 4.15 | 0.12 | 0 |
| C15 (iso) | 48.35 | 11.45 | 0 |
| C16 (iso) | 42.80 | 47.89 | 1.58 |
| C17 (iso) | 2.52 | 18.57 | 14.17 |
| C18 (iso) | 0.38 | 17.07 | 79.69 |
| C19 (iso) | 0 | 0 | 0.12 |
| C20 (iso) | 0 | 0 | 0.38 |
| C27 (iso) | 0 | 0 | 0.29 |
| Quantity of biogenic carbons (%) | 97 | 97 | 98 |
| Initial boiling point (° C.) | 247.0 | 259.5 | 293.6 |
| Boiling point 5% (° C.) | 255.7 | 270.2 | 296.7 |
| Boiling point 50% (° C.) | 258.9 | 274.5 | 298.5 |
| Boiling point 95% (° C.) | 266.8 | 286.4 | 305.3 |
| Final boiling point (° C.) | 269.0 | 287.5 | 324.1 |
| Biodegradability (28 days) (%) | 89 | 89 | 89 |
| Refractive index at 20° C. | 1.4336 | 1.4357 | 1.4394 |
| density at 15° C. (kg/m3) | 776.4 | 780.3 | 787.2 |
| Flash point (° C.) | 115 | 125 | 149 |
| Pour point (° C.) | −81 | −60 | −45 |
| Kinematic viscosity at 40° C. (cSt) | 2.49 | 2.94 | 3.87 |
| Vapor pressure at 20° C. (kPa) | <0.01 | <0.01 | <0.01 |

The following standards and methods were used to measure the above properties:
flash point: EN ISO 2719,
density at 15° C.: EN ISO 1185,
pour point: EN ISO 3016,
viscosity at 40° C.: EN ISO 3104,
boiling point: ASTM D86,
biodegradability: method OECD 301B,
pour point: ASTM D5950

The hydrocarbon fluid according to the invention thereby has excellent properties, in particular in terms of flash point, density, evaporation and conductivity, making it possible to obtain excellent properties when same is used as a diluent in an extraction solvent comprising an extractant. The extraction solvent used in the invention thereby makes it possible to selectively recover and reuse the metals present in the batteries during the recycling of the batteries.

1-11. (canceled)

12. A method for the liquid-liquid extraction of metals, the method comprising using a hydrocarbon fluid as diluent, said hydrocarbon fluid comprising at least 75% by weight of isoparaffins and less than 100 ppm by weight of aromatics, relative to the total weight of the hydrocarbon fluid, said hydrocarbon fluid exhibiting a biodegradability of at least 60% at 28 days, measured as per the standard OECD 301B.

13. The method according to claim 12, wherein the hydrocarbon fluid comprises, relative to the total weight of the hydrocarbon fluid:
at least 80% by weight of isoparaffins, and/or
at most 20% by weight of normal paraffins, and/or
at most 1% by weight of naphthenes, and/or
less than 50 ppm by weight of aromatics.

14. The method according to claim 12, wherein the hydrocarbon fluid comprises:
a flash point greater than or equal to 80° C. as per ASTM D93, and/or
a kinematic viscosity at 40° C. of less than or equal to 5 cSt, and/or
a biogenic carbon content of at least 90% by weight, relative to the total weight of the carbon atoms of the hydrocarbon fluid.

15. The method according to claim 12, wherein the hydrocarbon fluid comprises:
an initial boiling point and a final boiling point in the range going from 200 to 400° C., and/or
a difference between the final boiling point and the initial boiling point ranging from 10° C. to 80° C.

16. The method according to claim 12, wherein the hydrocarbon fluid comprises, relative to the total weight of the hydrocarbon fluid:
from 30 to 60% by weight of C15 isoparaffins and from 30 to 60% by weight of C16 isoparaffins, or
from 5 to 15% by weight of C15 isoparaffins, from 30 to 60% by weight of C16 isoparaffins, from 10 to 30% by weight of C17 isoparaffins, and from 10 to 30% by weight of C18 isoparaffins, or
from 10 to 30% by weight of C17 isoparaffins and from 60 to 90% by weight of C18 isoparaffins.

17. The method according to claim 12, wherein the hydrocarbon fluid is used in a mixture with from 0.01 to 5% by weight of one or more antioxidant additives, relative to the total weight of the hydrocarbon fluid and of the antioxidant additive(s).

18. The method according to claim 12, wherein the hydrocarbon oil is used as a diluent in a hydrometallurgical method comprising at least one liquid-liquid extraction of metals using an extraction solution comprising said diluent and at least one extractant.

19. The method according to claim 18, wherein the metals come from the recycling of one or more batteries.

20. A method of liquid-liquid extraction of metals comprising at least one step of contacting a solution of metals M with an extraction solvent, said extraction solvent comprising at least one diluent and at least one extractant, said diluent being a hydrocarbon fluid comprising at least 75% by weight of isoparaffins and less than 100 ppm by weight of aromatics, relative to the total weight of the hydrocarbon fluid, said hydrocarbon fluid having a biodegradability of at least 60% at 28 days, measured as per the standard OECD 301B.

21. A hydrometallurgical method for recycling batteries, said method comprising:
a step of dissolving the metals present in at least one battery, in particular in the electrodes of said at least one battery, to obtain a solution of metals M,
optionally, a clarification step carried out on said solution of metals M in order to remove the residues that are not dissolved in the solution of metals,
a method of liquid-liquid extraction of metals as defined in claim 20.

22. A method of liquid-liquid extraction of metals according to claim 20 or a hydrometallurgical method for recycling batteries, wherein the hydrocarbon fluid has one or more of the following features:
the hydrocarbon fluid comprises, relative to the total weight of the hydrocarbon fluid:
at least 80% by weight of isoparaffins, and/or
at most 20% by weight of normal paraffins, and/or
at most 1% by weight of naphthenes, and/or
less than 50 ppm by weight of aromatics;
the hydrocarbon fluid comprises:
a flash point greater than or equal to 80° C. as per ASTM D93, and/or
a kinematic viscosity at 40° C. of less than or equal to 5 cSt, and/or
a biogenic carbon content of at least 90% by weight, relative to the total weight of the carbon atoms of the hydrocarbon fluid;
the hydrocarbon fluid comprises:
an initial boiling point and a final boiling point in the range going from 200 to 400° C., and/or
a difference between the final boiling point and the initial boiling point ranging from 10° C. to 80° C.;
the hydrocarbon fluid comprises, relative to the total weight of the hydrocarbon fluid:
from 30 to 60% by weight of C15 isoparaffins and from 30 to 60% by weight of C16 isoparaffins, or
from 5 to 15% by weight of C15 isoparaffins, from 30 to 60% by weight of C16 isoparaffins, from 10 to 30% by weight of C17 isoparaffins, and from 10 to 30% by weight of C18 isoparaffins, or
from 10 to 30% by weight of C17 isoparaffins and from 60 to 90% by weight of C18 isoparaffins.

23. The method according to claim 12, wherein the hydrocarbon fluid comprises, relative to the total weight of the hydrocarbon fluid:
at least 90% by weight, and/or
at most 10% by weight, and/or
at most 1% by weight of naphthenes, and/or
less than 50 ppm by weight of aromatics.

24. The method according to claim 12, wherein the hydrocarbon fluid comprises, relative to the total weight of the hydrocarbon fluid:
at least 95% by weight, and/or
at most 5% by weight, and/or
at most 1% by weight of naphthenes, and/or
less than 50 ppm by weight of aromatics.

25. The method according to claim 12, wherein the hydrocarbon fluid comprises:
a flash point greater than or equal to 110° C. as per ASTM D93, and/or
a kinematic viscosity at 40° C. of less than or equal to 4 cSt, and/or
a biogenic carbon content of at least 95% by weight, relative to the total weight of the carbon atoms of the hydrocarbon fluid.
